(19) United States
(12) Patent Application Publication
(10) Pub. No.: US 2026/0064820 A1
(43) Pub. Date: Mar. 5, 2026

(54) DETERMINATION METHOD, CONTROL METHOD, NON-TRANSITORY COMPUTER-READABLE RECORDING MEDIUM, AND INFORMATION PROCESSING DEVICE

(71) Applicant: Fujitsu Limited, Kawasaki-shi (JP)

(72) Inventors: Ryoichi FUNABASHI, Kawasaki-shi (JP); Narishige ABE, Kawasaki-shi (JP); Yoshihiro MATSUYAMA, Kawasaki (JP)

(73) Assignee: Fujitsu Limited, Kawasaki-shi (JP)

(21) Appl. No.: 19/385,219

(22) Filed: Nov. 11, 2025

Related U.S. Application Data
(63) Continuation of application No. PCT/JP2023/021321, filed on Jun. 8, 2023.

(51) Int. Cl. G06F 21/32; G06T 7/20; G06T 7/70; G06V 40/20

(52) U.S. Cl. CPC G06F 21/32; G06T 7/20; G06T 7/70; G06V 40/20; G06T 2207/30242

(57) ABSTRACT

In a determination method, when an object indicating a person approaching a service providing device is detected based on a result of analyzing an image taken by a camera, a location where the service providing device will start providing a service is determined, in accordance with a movement of the target.

### CROSS-REFERENCE TO RELATED APPLICATION

This application is a continuation application of PCT/JP2023/021321, filed on June 8, 2023, the entire contents of which are incorporated herein by reference.

### FIELD

A certain aspect of embodiments described herein relates to a determination method, a control method, a non-transitory computer-readable recording medium, and an information processing device.

### BACKGROUND ART

Technology has been disclosed in which a service point is set up and a specific service is provided to an object when the object enters the service point (see, for example, Japanese Patent Application Publication No. 2007-179392).

### SUMMARY

In one aspect, in a determination method, when an object indicating a person approaching a service providing device is detected based on a result of analyzing an image taken by a camera, a location where the service providing device will start providing a service is determined, in accordance with a movement of the target.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is an authentication space.

FIG. 2 is an authentication space.

FIGS. 3A and 3B are outlines of an embodiment.

FIG. 4 is detection of a number of people approaching a service providing device.

FIG. 5A is a block diagram of an overall structure of a biometric authentication system according to an embodiment.

FIG. 5B is a functional block diagram of each function of an information processing device.

FIG. 6 is a flow chart of a registration process.

FIG. 7 is a diagram of an example of an ID table stored in a location information storage.

FIG. 8 is a flow chart of location information acquisition process executed by an information processing device.

FIG. 9 is a diagram of a location information table stored in a location information storage.

FIG. 10 is a flow chart of a service provision process executed by an information processing device.

FIG. 11 is a diagram for explaining details of estimation in step S25.

FIG. 12 is a diagram for explaining details of step S27.

FIG. 13 is a diagram for explaining details of step S28.

FIG. 14 is a diagram for explaining another example of step S27.

FIG. 15 is a diagram for explaining an outline of an applicable embodiment.

FIG. 16 is a flow chart of a processing in an applicable embodiment.

FIG. 17 is a block diagram of a hardware configuration of an information processing device.

### DESCRIPTION OF EMBODIMENTS

A moving speed of each target varies. As a result, there is a risk that services are not provided to each target at the appropriate time.

Biometric authentication is a technique that uses biometric features such as fingerprints, faces, or veins to verify identity. In biometric authentication, identity verification is performed by comparing (matching) the biometric feature data for matching obtained by the biometric sensor in a situation where identity verification is required with registered biometric feature data that has been registered in advance, and determining whether the similarity is greater than or equal to the identity determination threshold. Biometric authentication has been used in a variety of fields, including bank ATMs and entry and exit management, and in recent years it has also begun to be used for cashless payments in supermarkets and convenience stores.

These biometric authentications are authentication at a "point" performed at a specific authentication spot, such as in front of an authentication machine. However, authentication with "points" will cause the authentication state to break when the user leaves the authentication spot, and will be authenticated each time when receiving service again or where authentication is performed multiple times. Therefore, there is a need for a continuous authentication technology that allows the authentication state to continue and enjoy the service after one authentication without the need to perform multiple authentication actions.

Here we will explain an overview of continuous authentication technology. Continuous authentication mainly involves the following authentication:

First, we will need to verify check-in. The user performs highly accurate authentication using palm vein authentication or fingerprint authentication at a gate, and by photographing the user's appearance when the authentication is successful with the camera, the user's ID and feature information acquired with the camera are registered by linking it.

Next is the authentication on a line. The authentication state is maintained by tracking the same person between multiple cameras in the authentication space and performing authentication processing. This allows individual services to be provided anywhere within the authentication space. Furthermore, since no authentication operations are required each time, the service can be provided at the optimal timing.

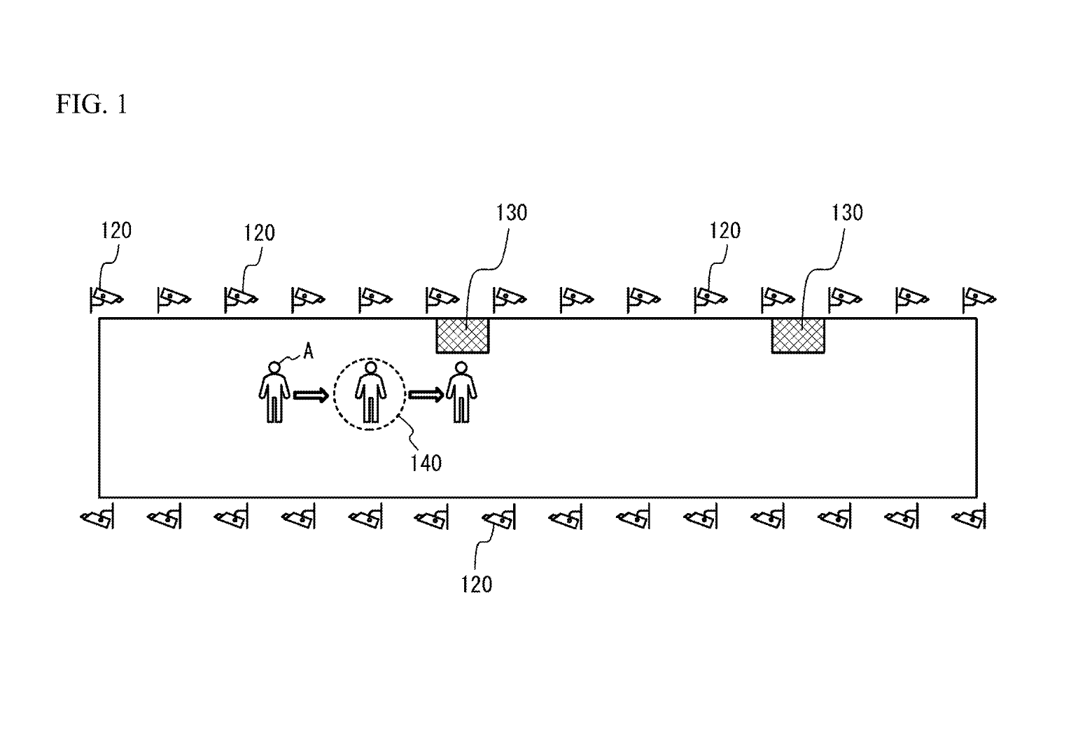

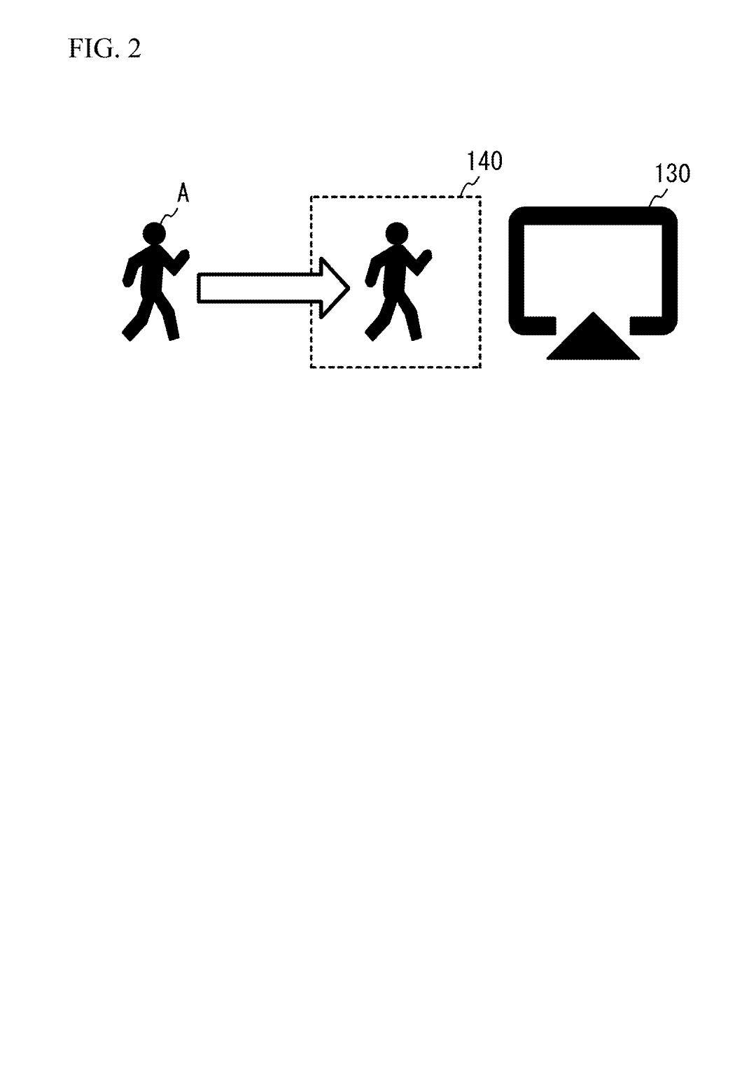

For example, as illustrated in FIGS. 1 and 2, one or more service providing devices 130 are installed in the authentication space. Additionally, a plurality of tracking cameras 120 are installed at different locations in the authentication space. FIG. 1 is a view seen from above, and FIG. 2 is a view seen from the side.

The tracking camera 120 acquires images at a predetermined time interval. A person A can be detected from images obtained from each of the tracking cameras 120. Furthermore, the detected person A can be tracked, by extracting feature data from the detected person A and tracking the person A within the same image or identifying (Re-ID) among multiple images. Furthermore, by comparing the feature data of the tracked person A with the registered data, it is possible to continue the authentication state of the tracked person A.

The location information of each of the tracking cameras 120 is stored, and the location of the person A can be detected from the location of the tracking camera 120 where an image of the person A has been acquired, and the location and size of the person A in the image, or the like. By detecting the location of the person A, it is possible to detect which of the service providing devices 130 the person A can receive services.

For example, when the image is captured by the specific tracking camera 120, it is detected that the person A is located near the service providing device 130 and the person A can receive services from the service providing device 130.

For example, a service point 140 corresponding to the service providing device 130 is set in advance. When it is detected that the person A has entered the service point 140, the service application of the service providing device 130 corresponding to the service point 140 is started to start providing the service. By doing this, when the person A enters the specific service point 140, it is possible to provide services for the service application that provides information, payment, or the like.

When detecting the position of the person A using the tracking camera 120, a certain amount of time (for example, about 100 msec) is required, resulting in a time lag. Furthermore, when considering the service application, it is necessary to set the service point 140 slightly ahead of the service providing device 130 on the flow of the person A.

However, if a service application is intended to provide information to the person A on the move, if the timing is off, there is a risk that appropriate services will not be possible. For example, if the service point 140 is too far from the service providing device 130, the service provided by the service providing device 130 may not be recognized as a service to the person A. On the other hand, if the service point 140 is too close to the service providing device 130, there is a risk that person A may have passed the service providing device 130 when the service providing device 130 provides the service.

Therefore, it is conceivable, for example, to set the service point 140 in advance by a predetermined distance from the service providing device 130, with the assumption that the person A approaches the service providing device 130 at a standard moving speed. If the person A moves so as to approach the service providing device 130 at a standard moving speed, the person A who has entered the service point 140 can provide the service at an appropriate time. However, movement speeds vary depending on the person. Therefore, there is a risk that the service is not provided to each person at an appropriate time.

Therefore, in the following embodiment, a determination method, a determination program, and an information processing device that can provide services at a timing that corresponds to the movement of the target person will be described.

### Embodiment

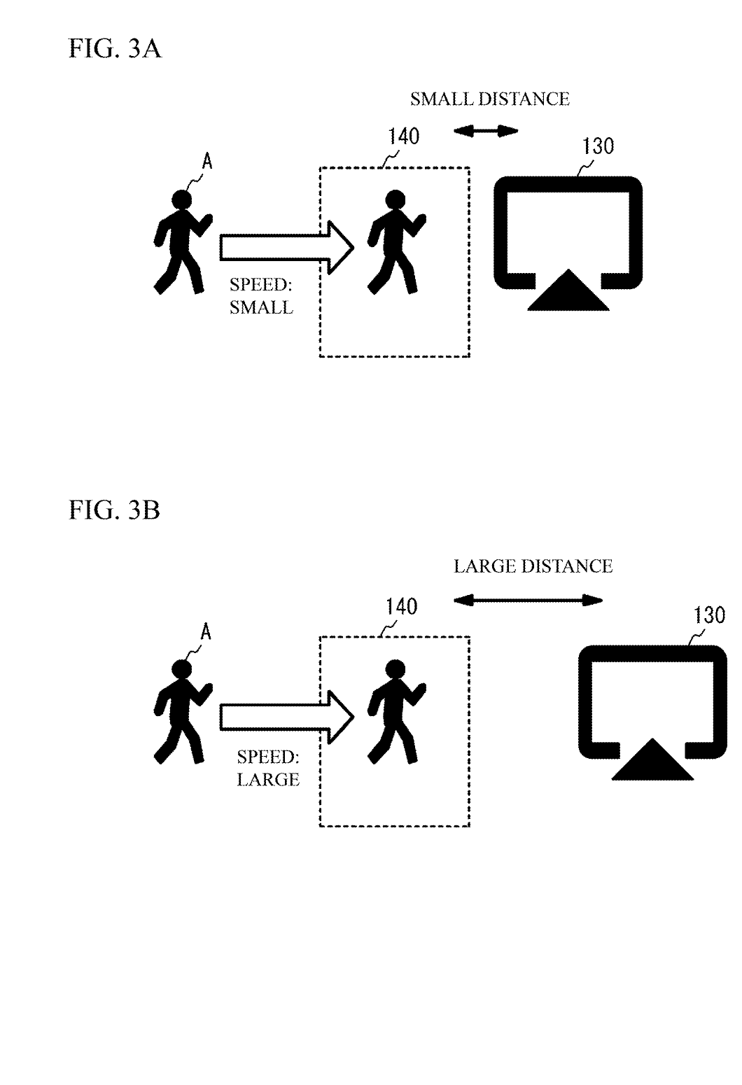

First, an outline of an embodiment will be explained. As illustrated in FIG. 3A, the location information of a target person is obtained using the tracking camera 120 illustrated in FIG. 1. By acquiring this location information in chronological order, the moving speed of the target person approaching the direction of the service providing device 130 is detected. The slower the moving speed, the shorter the distance between the service providing device 130 and the service point 140 is reduced. As illustrated in FIG. 3B, the faster the moving speed in which the target person approaches the service providing device 130, the longer the distance between the service providing device 130 and the service point 140 is. When the target person enters the service point 140, the service providing device 130 is ordered to start providing a specified service. In this way, by determining the service point 140 in accordance with the movement of the target person, the service providing device 130 can provide the service at an appropriate timing according to the movement of the target person.

For example, it is assumed that the inside of an airport building is the authentication space. For example, an electronic guide board for guiding the boarding gate at an airport is envisaged as a service providing device. For example, it is assumed that when a person enters the service point 140, an image informing the person's boarding gate is displayed on the electronic guide board. If the person's ID can be identified, it is possible to provide the information necessary by the person.

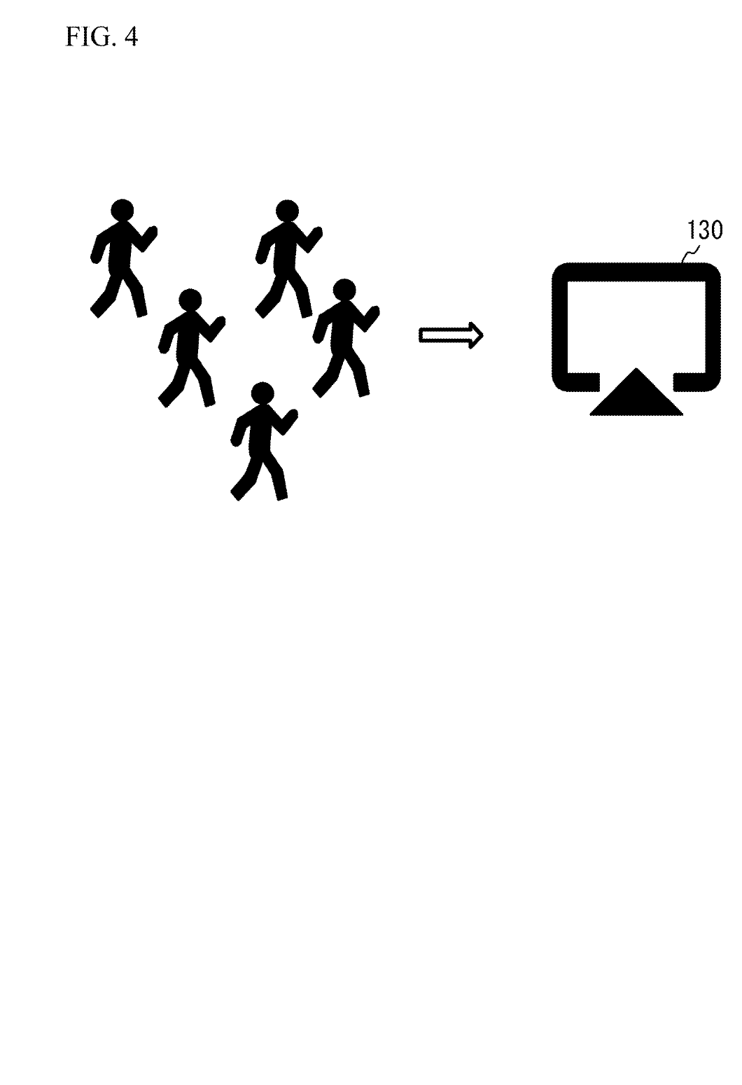

Furthermore, the number of people approaching the service providing device may be detected. For example, as illustrated in FIG. 4, the number of people can be detected by counting the person whose ID is identified using the tracking camera 120. The content of the services provided by the service providing device 130 may be adjusted according to the number of people. For example, when the number of people is greater than the threshold, the service providing device 130 may display the content targeting an unspecified number of people rather than the content targeting a specific person.

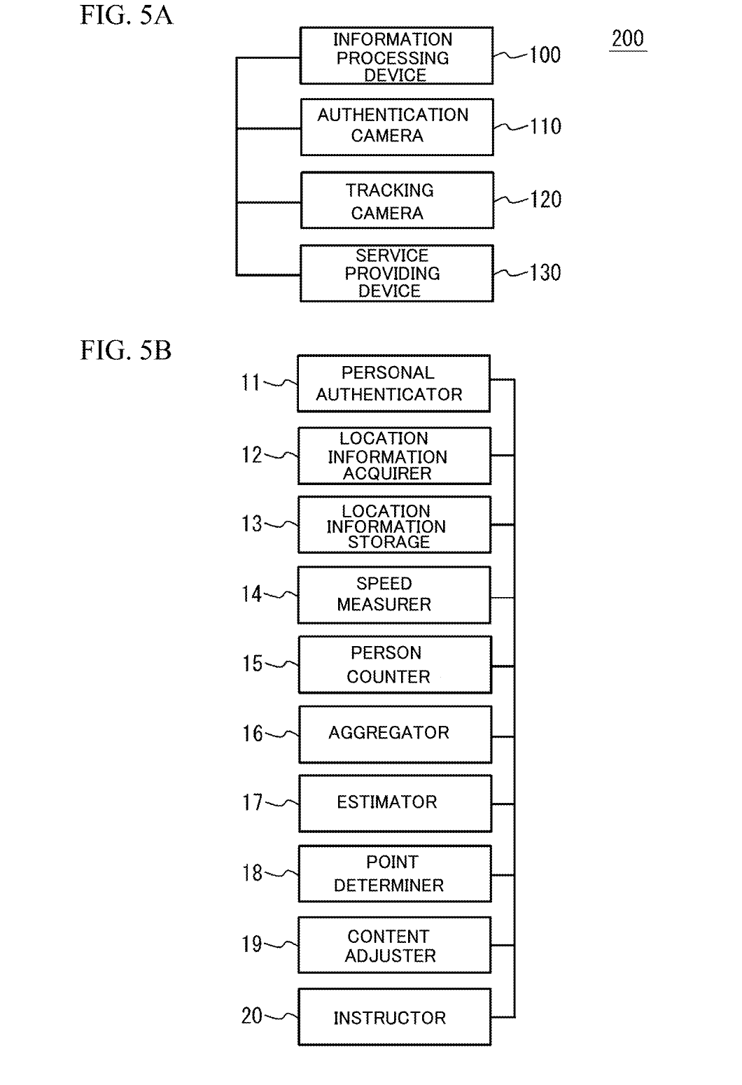

Next, details of this embodiment will be explained. FIG. 5A is a block diagram illustrating the overall structure of a biometric authentication system 200 according to the embodiment. As illustrated in FIG. 5A, the biometric authentication system 200 includes an information processing device 100, an authentication camera 110, the tracking camera 120, the service providing device 130, and the like. These devices are connected via a telecommunications line. The service providing device 130 may provide the service by displaying predetermined information, or may provide the service by outputting a predetermined audio or the like.

The authentication camera 110 is a camera provided at a gate in the authentication space, and is installed in a position where it is easy to obtain information on the person's feature. The tracking camera 120 is a camera for tracking people in the authentication space, and is installed on a ceiling or the like to make it easier to track people. The number of the tracking camera 120 may be one or more. The service providing device 130 is a terminal that provides services to users within the authentication space. The number of the service providing device 130 may be one or more.

FIG. 5B is a functional block diagram of each function of the information processing device 100. As illustrated in FIG. 5B, the information processing device 100 functions as a personal authenticator 11, a location information acquirer 12, a location information storage 13, a speed measurer 14, a person counter 15, an aggregator 16, an estimator 17, a point determiner 18, a content adjuster 19, an instructor 20, and the like.

Next, each of the processes executed by the information processing device 100 will be described.

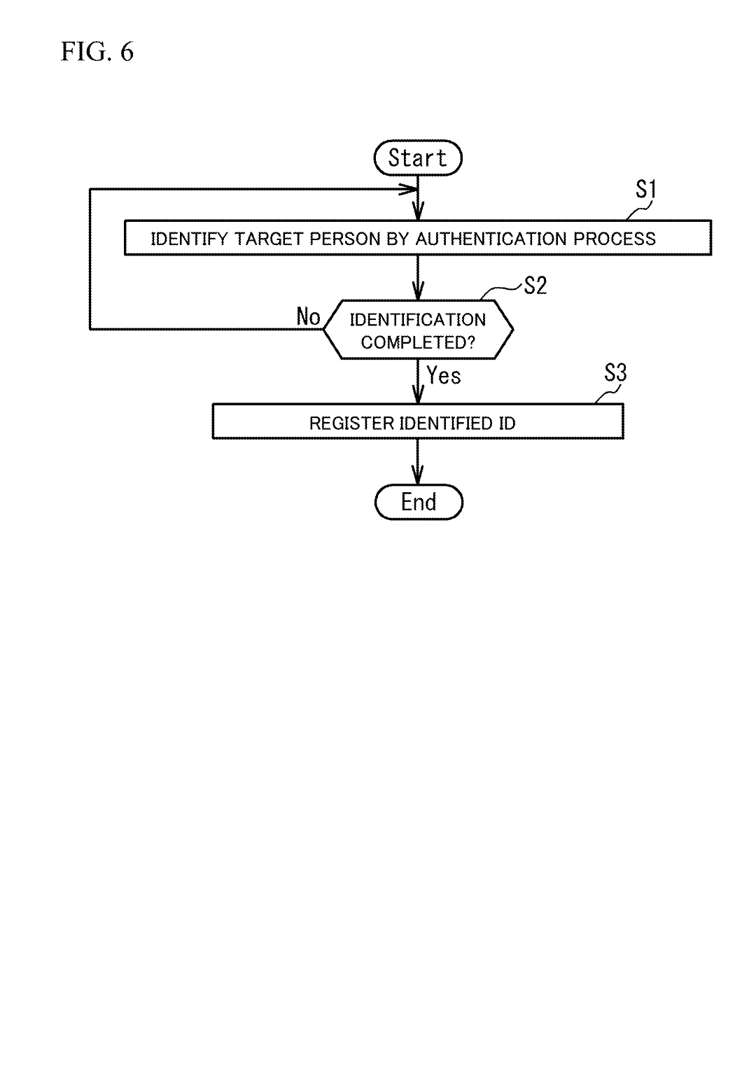

(Registration Process) FIG. 6 is a flow chart of the registration process. The personal authenticator 11 identifies the target person who needs to be registered through the authentication process (step S1). For example, the personal authenticator 11 acquires matching data such as face features from the authentication camera 110. Next, the personal authenticator 11 compares the registered data of each person registered in advance with the matching data to calculate the similarity.

Next, the personal authenticator 11 determines whether or not the identification has been completed (step S2). For example, the personal authenticator 11 identifies the target person as a person with an ID (identification information) associated with the registered data with the highest similarity, and is determined to be "Yes" in step S2. If none of the similarities exceed the threshold, identification is not completed and a determination is made as "No" in step S2.

If it is determined in step S2 as "No", the process is executed again from step S1. If it is determined in step S2 as "Yes", the ID specified in step S2 is registered in the ID table stored in the location information storage 13 (step S3). After that, execution of the flow chart ends.

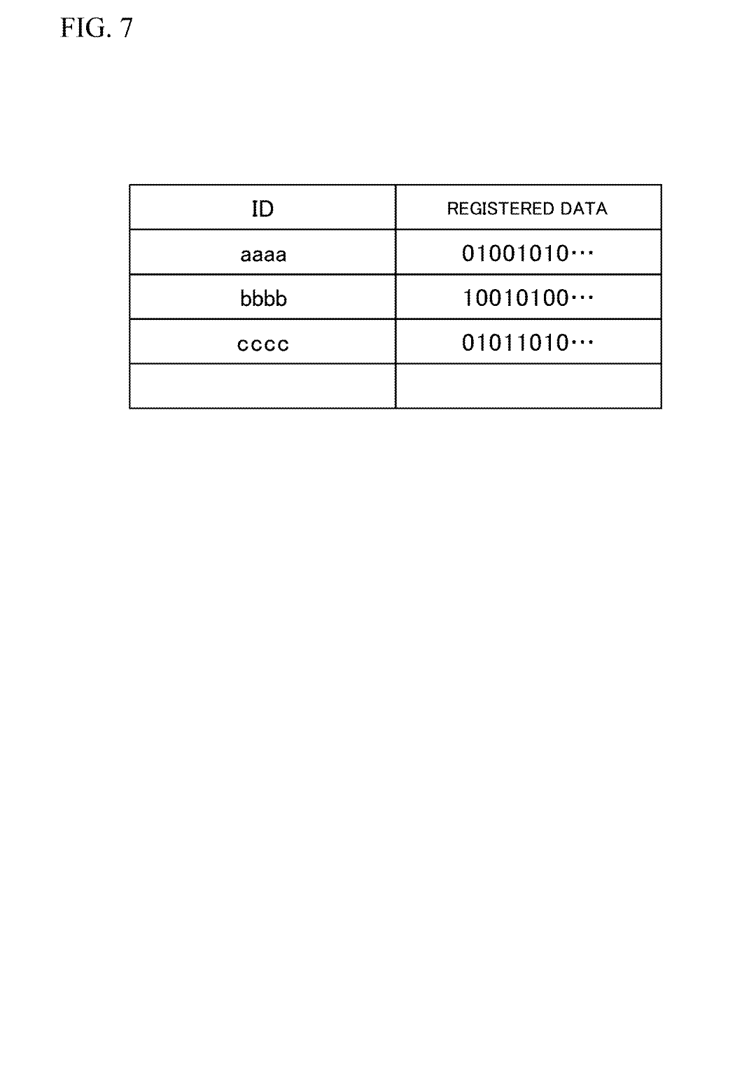

FIG. 7 is a diagram illustrating an example of an ID table stored in the location information storage 13. As illustrated in FIG. 7, in the ID table, registration data and the like are associated with each ID.

The authentication process in the above registration process is not particularly limited. For example, the ID may be identified by comparing the highly accurate matching biometric data such as veins, fingerprints, iris or the lie with data of each person registered in advance, and the appearance feature data such as facial features acquired by the camera may be associated with the ID and registered in the location information storage 13 as registered data.

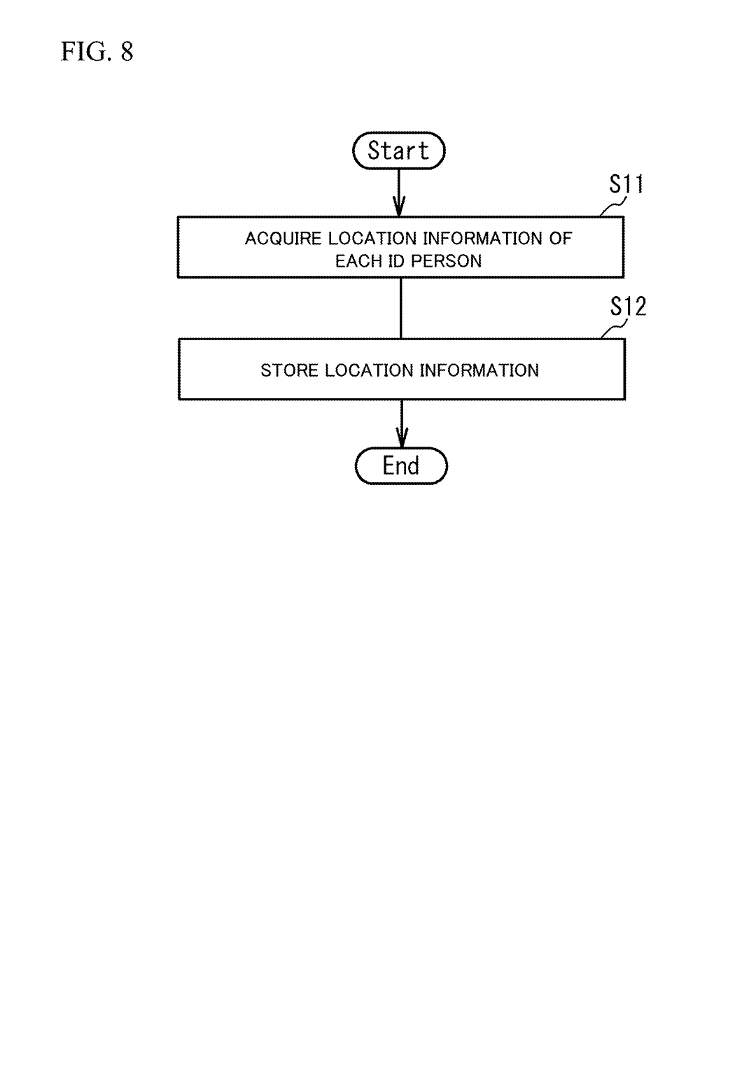

(Location information acquisition process) FIG. 8 is a flow chart of the location information acquisition process executed by the information processing device 100. The flow chart of FIG. 8 is repeated at a predetermined period. As illustrated in FIG. 8, the location information acquirer 12 uses the image acquired by the tracking camera 120 to acquire the location of the person of each ID registered in the ID table stored in the location information storage 13 (step S11).

For example, the location information acquirer 12 acquires images from each of the tracking cameras 120. Next, the location information acquirer 12 detects the person area from each of the acquired images. The detection of the person area includes a method of detecting the area of a moving object using background differences, a method of learning the person's features in advance and detecting the person's features from the input image, and the like. Next, the location information acquirer 12 extracts feature data on the image from each detected person area and stores it as feature data corresponding to the person area. Next, the location information acquirer 12 identifies the person with the ID of the registered data that has the highest similarity among the feature data stored in the location information storage 13. The location of the person can be detected according to the location of the tracking camera 120 where an image of a person with a specified ID is acquired, and the location and size of the person area in the image.

Next, the location information acquirer 12 stores the location information acquired in step S11 in chronological order in the location information table stored in the location information storage 13 (step S12). After that, execution of the flow chart ends.

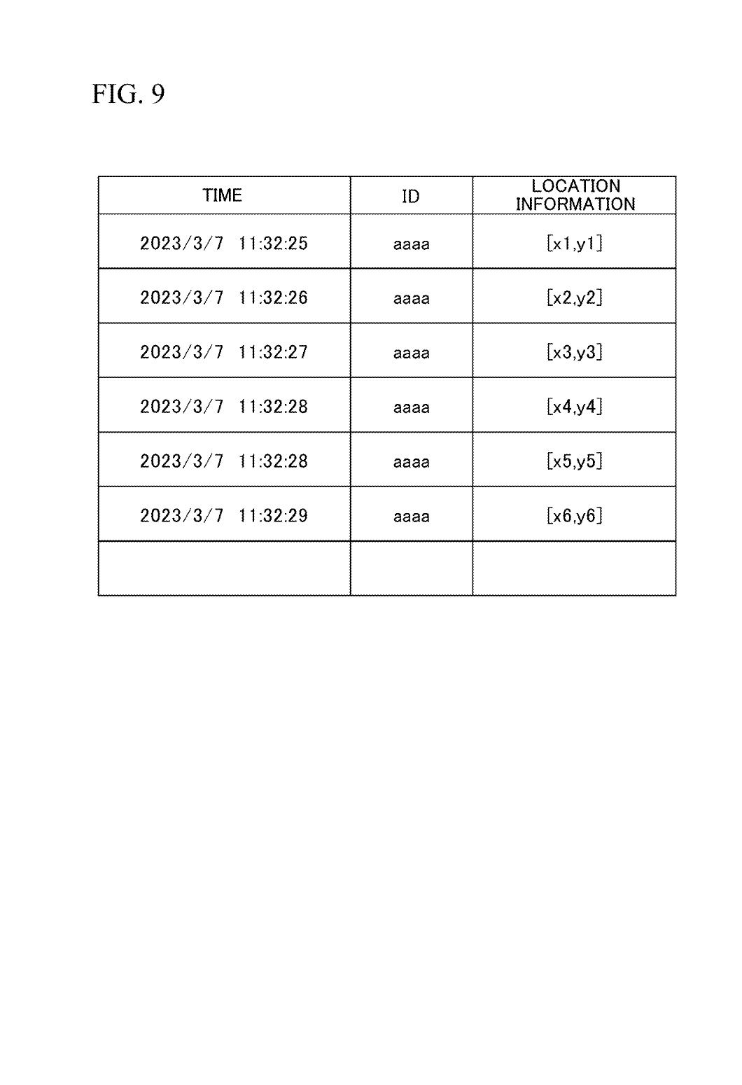

FIG. 9 is a diagram illustrating an example of the location information table stored in the location information storage 13. As illustrated in FIG. 9, in the location information table, location information is associated with each ID in chronological order. Although ID=aaaa is described in FIG. 9, location information may be associated with other IDs in chronological order.

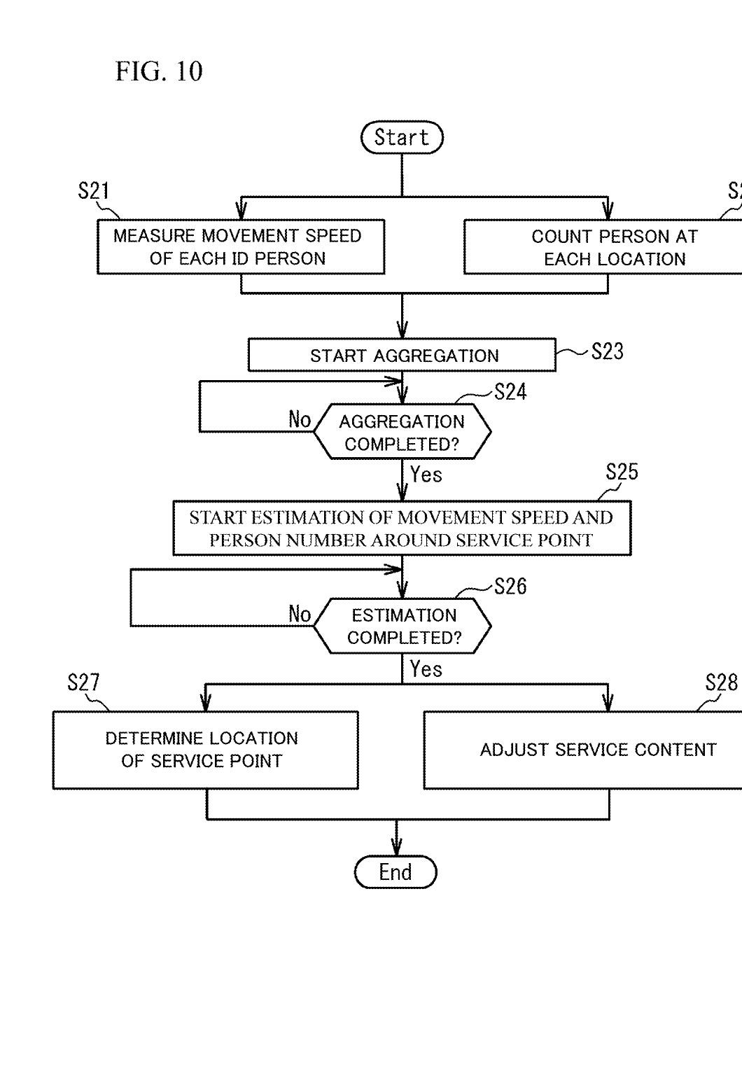

(Service provision process) FIG. 10 is a flow chart of the service provision process executed by the information processing device 100. As illustrated in FIG. 10, the speed measurer 14 refers to the location information table stored in the location information storage 13 and measures the moving speed of the person with each ID (step S21). For example, the speed measurer 14 can measure the moving speed of each ID from the location information stored in time series. For example, the moving speed approaching the closest service providing device 130 can be measured. Statistical processing can be used to measure moving speed. For example, the average speed at a given time can be measured.

In parallel with step S21, the person counter 15 refers to the location information table stored in the location information storage 13 and measures the number of people at each location in the authentication space (step S22). For example, the number of people within each specified range that is predetermined in the authentication space can be measured.

After execution of steps S21 and S22, the aggregator 16 starts counting the information obtained in steps S21 and S22 (step S23).

Next, the aggregator 16 determines whether the aggregation that began in step S23 is completed or not (step S24). If it is determined in step S24 as "No", step S24 is executed again after a predetermined time.

If it is determined as "Yes" in step S24, the estimator 17 starts estimating the moving speed and number of people in the area surrounding each service point (step S25).

Next, the estimator 17 determines whether the estimation that began in step S25 is completed or not (step S26). If it is determined in step S26 as "No", step S26 is executed again after a predetermined time.

If it is determined in step S26 as "Yes", the point determiner 18 determines the location of the service point 140 in accordance with the moving speed estimated by the estimator 17 (step S27). For example, the service point 140 is determined as described in FIGS. 3A and 3B.

If it is determined in step S26 as "Yes", in parallel with step S27, the content adjuster 19 adjusts the service contents of each service providing device in accordance with the number of people estimated by the estimator 17 (step S28). For example, the service content is adjusted as explained in FIG. After that, execution of the flow chart ends.

As described in FIGS. 3A and 3B, when a target person enters the service point 140, the instructor 20 instructs the service providing device 130 to start providing a specified service.

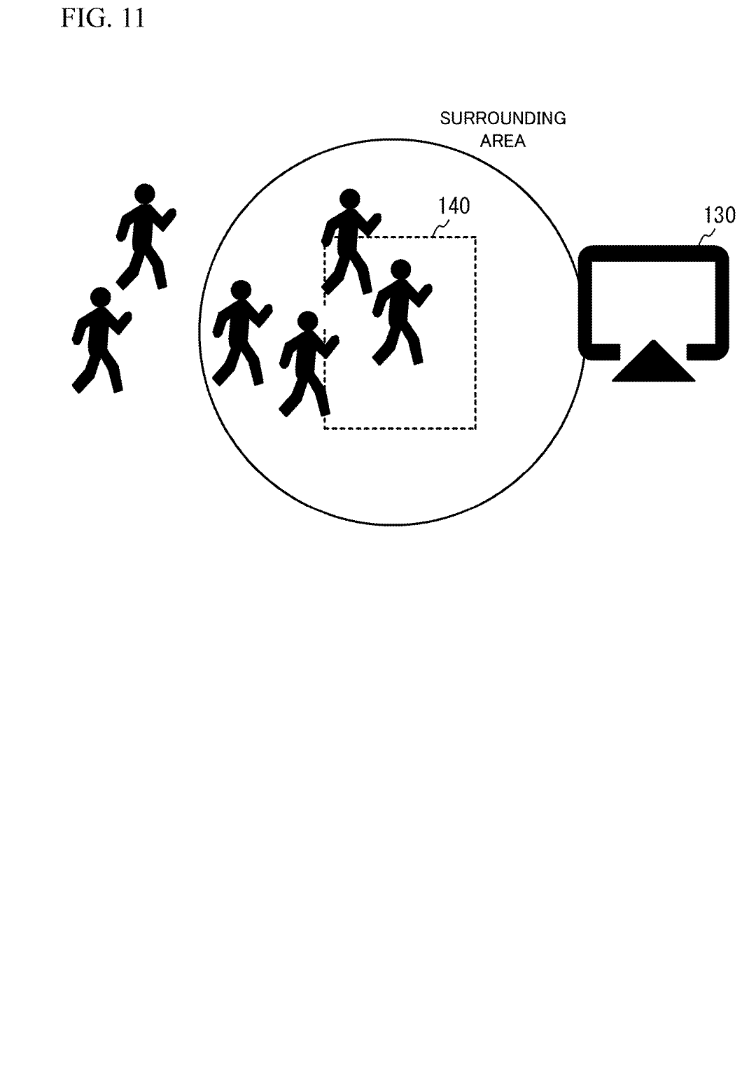

FIG. 11 is a diagram for explaining the details of the estimation in step S25. For example, as illustrated in FIG. 11, the moving speed of a plurality of people in the surrounding area including the service point 140 may be estimated as the moving speed of a person in the surrounding area of the service point. For example, the average value of the average speeds of a plurality of people over a given time range may be estimated as the moving speed of a person in the area surrounding the service point. Alternatively, among a plurality of people, a particular target person may be focused on, and the average speed over a certain time range may be estimated as the moving speed of a person in the area surrounding the service point. Alternatively, the moving speed for each individual may be estimated as the moving speed of each person in the area surrounding the service point.

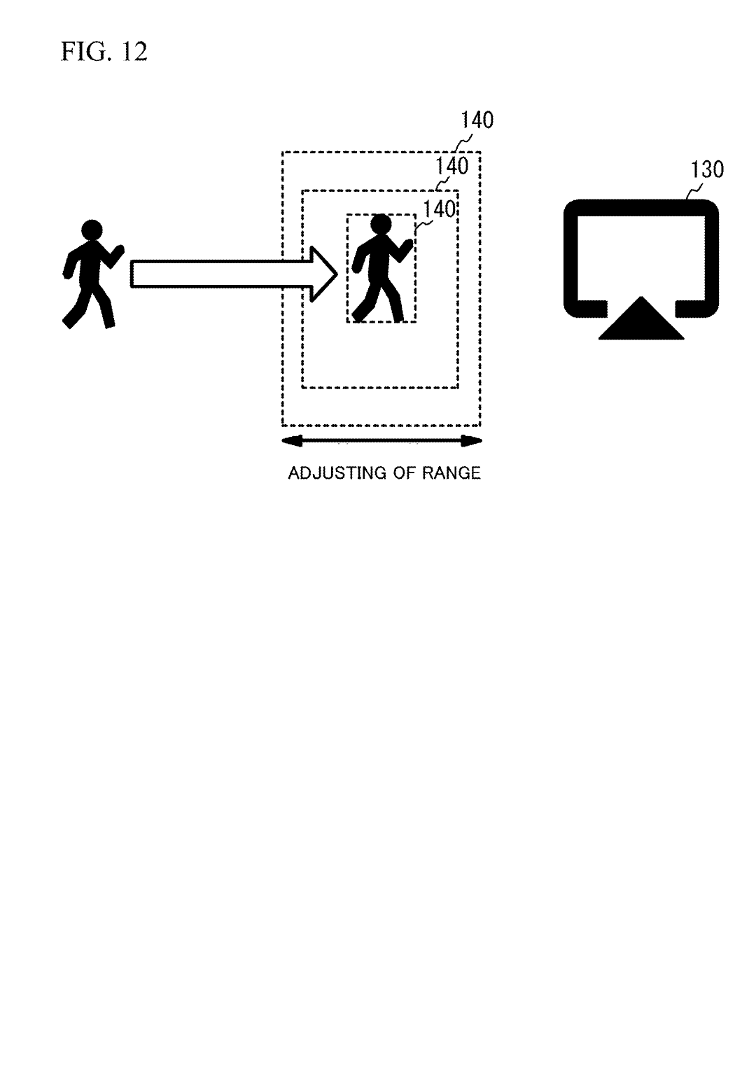

FIG. 12 is a diagram for explaining the details of step S27. For example, as illustrated in FIG. 12, the range of the service point 140 may be adjusted according to the results of estimation by the estimator 17. For example, the size, the shape or the like of the service point 140 may be adjusted. For example, if the moving speed of a person in the area surrounding the service point is high, the service point 140 may be enlarged. Alternatively, the location and range of the service point 140 may be adjusted for each individual. Alternatively, the range of the service point 140 may also be enlarged for a person with a fast moving speed.

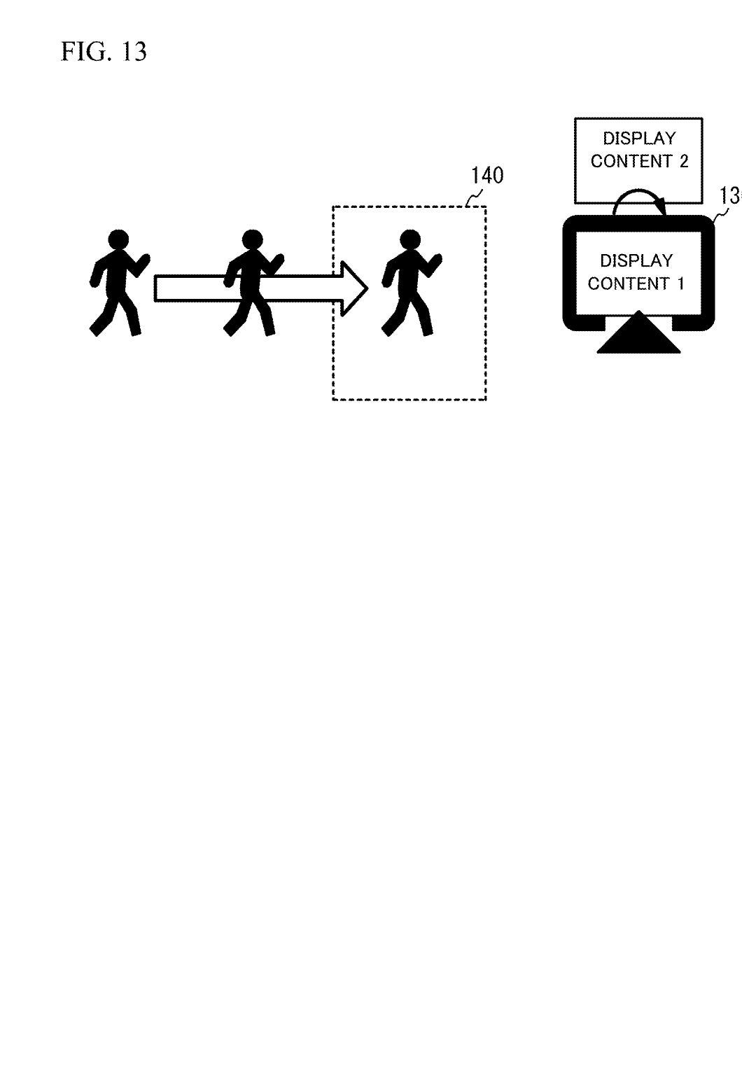

FIG. 13 is a diagram for explaining the details of step S28. For example, as illustrated in FIG. 13, the content adjuster 19 may change the displayed content based on the estimation result of the estimator 17.

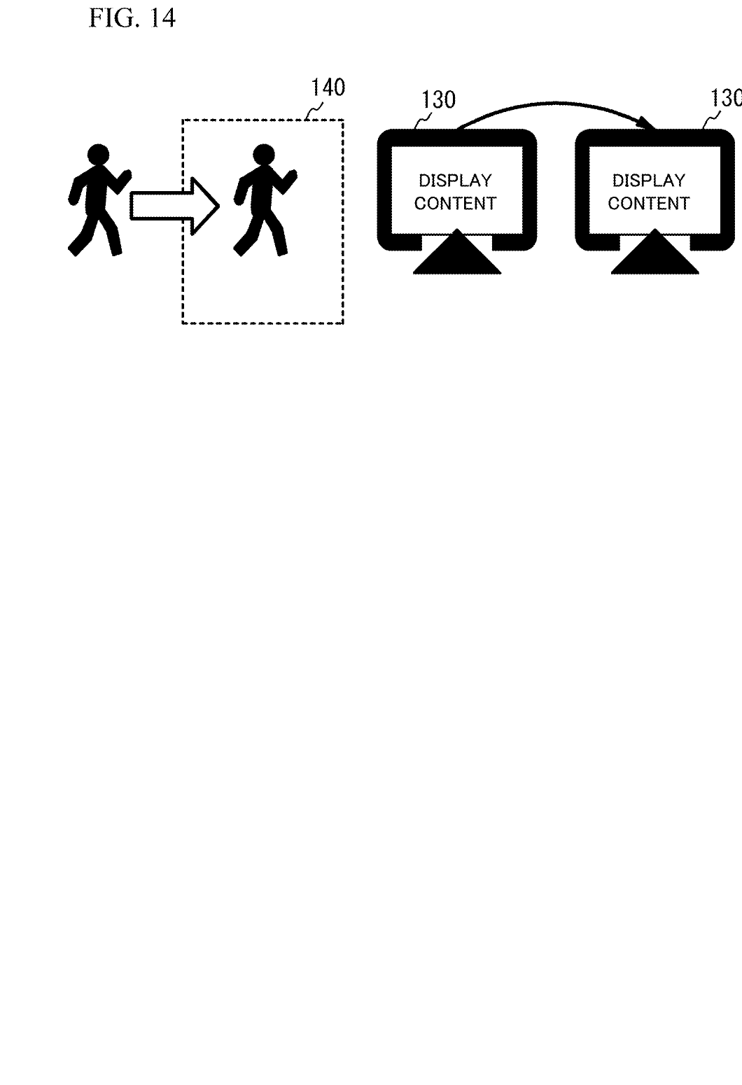

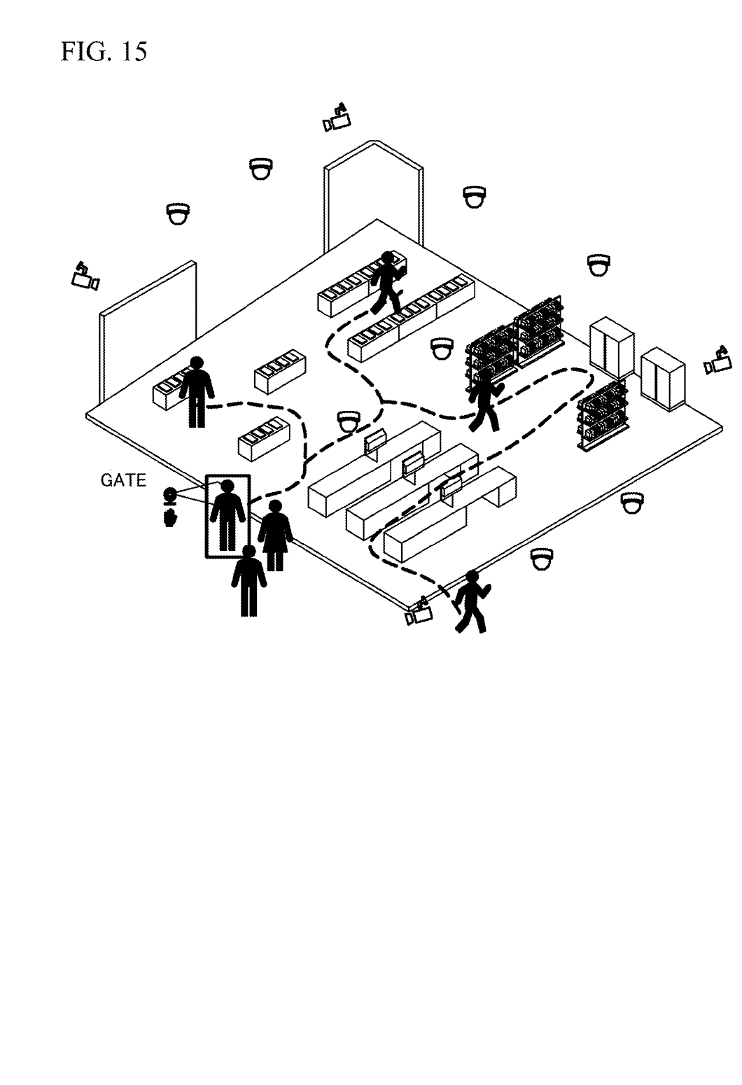

FIG. 14 is a diagram for explaining another example of step S27. For example, as illustrated in FIG. 14, the point determiner 18 may change the service providing device that displays the service contents based on the estimation result of the estimator 17. For example, when the moving speed estimated by the estimator 17 is high, the instructor 20 may instruct the service providing device 130 among the multiple service providing device devices 130 that is farther than the target person to start providing the service. When the moving speed estimated by the estimator 17 is slow, the instructor 20 may instruct the service providing device 130, which is closer to the target person, among the multiple service providing devices 130, to start providing the service.

<Applicable embodiment> Next, an applicable embodiment will be described with reference to FIG. 15. The information processing device 100 can analyze the behavior of the person checked in using the image captured by the tracking camera 120. Facilities include railway facilities, airports, and shops. In addition, gates located at the facilities are located at the entrances to stores, railway facilities, airport boarding gates, or the like.

First, we will explain an example where the targets to check in are railway facilities or airports. When it comes to railway facilities or airports, gates are located at train facilities ticket gates, airport counters or inspection sites. At this time, when the biometric information of a person is pre-registered as a target for a passenger on a train or plane, the information processing device 100 determines that authentication using the biometric information of a person has been successful.

Next, an example will be explained as a store where the check-in is. When it is a store, the gate is located at the entrance to the store. At this time, when the biometric information of a person is registered as a member of the store as a check-in, the information processing device 100 determines that authentication using the biometric information of the person has been successful.

Here we will explain the details of check-in. Authentication is performed from biometric information obtained by sensors or cameras. This identifies the ID and name of the target person to be checked in.

At this time, the information processing device 100 uses the tracking camera 120 to acquire an image of the target person to be checked in. Next, the information processing device 100 detects a person from the image. The information processing device 100 tracks the person detected from the image captured by the tracking camera 120 between frames. The information processing device 100 associates the ID or name of the person to be checked in to the person to be tracked.

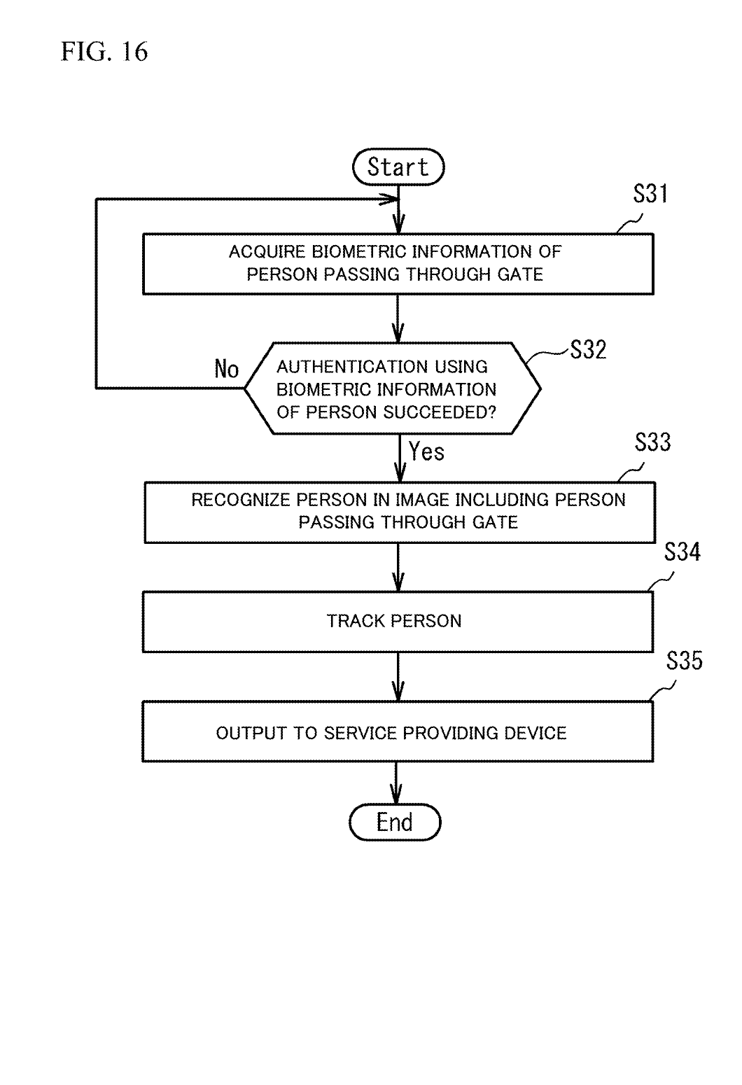

Here, an application embodiment will be explained using FIG. 16, using a store as a facility. When checking in, the information processing device 100 acquires biometric information of a person passing through a gate arranged at a predetermined location within the store (step S31). Specifically, the information processing device 100 obtains, from the biometric sensor, vein images or the like obtained by a vein sensor mounted on a gate located at an entrance within a store, and performs authentication. At this time, the information processing device 100 identifies the user's ID, name or the like from the biometric information.

The biometric sensor is mounted on a gate located at a specified location in the facility and detects biometric information of a person passing through the gate. Additionally, the tracking camera 120 is installed on the ceiling of the store. At this time, instead of the biometric sensor, the information processing device 100 may acquire biometric information from a facial image taken by a camera mounted on a gate located at an entrance within the shop, and perform authentication.

Next, the information processing device 100 determines whether authentication using the biometric information of the person has been successful (step S32). If the authentication is successful (Yes in step S32), the process proceeds to step S33. On the other hand, if the authentication fails (No in step S32), the process proceeds to step S31.

The information processing device 100 identifies the person included in the image including the person passing through the gate (step S33). Specifically, when the authentication using the biometric information of the person is successful, the information processing device 100 analyzes an image including a person passing through the gate, and identifies a person included in the image as a person checked into the facility. The information processing device 100 then stores the identification information of the person specified from the biometric information with the identified person in the storage in association with the identified person. At this time, the information processing device 100 stores the ID or name of the target person to be checked in and the identified person in association with the identified person.

After that, the information processing device 100 tracks down the person (step S34). Specifically, the information processing device 100 analyzes the video obtained by the tracking camera 120, identifies the ID or name of the target person to be checked in, and tracks the person moving around the store. That is, the information processing device 100 identifies the identity of the person photographed by the tracking camera 120. The information processing device 100 then identifies the route that tracks the identified person, and thus identifies the locus within the facility of the identified person.

Furthermore, the information processing device 100 outputs to the service providing device 130 a service related to the ID and name of the target person to be checked in (step S35). Specifically, the information processing device 100 causes the service providing device 130 to launch a service application associated with the ID or name of the person to be checked in. For example, when it is detected that the person A has entered the service point 140, the service application of the service providing device 130 corresponding to the service point 140 is started to start providing the service. At this time, the information processing device 100 selects a service application to be started by the service providing device 130 from among the multiple service applications, depending on the ID or name of the person A to check in.

Additionally, after a person checks in, it is possible to analyze the person's purchasing behavior by identifying whether the person checked in has acquired the products placed inside the store.

Here we will explain the person's purchasing behavior. The information processing device 100 analyzes images including the tracked person, and generates skeletal information of the person. The information processing device 100 then uses the generated skeletal information to identify the behavior of the tracked person who has acquired the product. That is, after the person checks in inside the store, the information processing device 100 determines whether or not any of the items arranged in the store has been acquired from the multiple items placed in the store, from when the person enters to when they leave the store. The information processing device 100 then stores the result of whether or not the product has been acquired and the ID or name of the target person to be checked in.

Specifically, using existing object detection technology, the information processing device 100 identifies customers staying in the store and products placed in the store from the captured images using the tracking camera 120. Furthermore, using existing skeletal detection technology, the information processing device 100 generates skeletal information of the specified person from images captured by the tracking camera 120 to estimate the location and posture of each joint of the person. The information processing device 100 then detects the action of holding the item, and the action of adding the item to a basket or cart, based on the locational relationship between the skeleton information and the item. For example, the information processing device 100 determines that the product is held when the skeletal information located at the location of the person's arm overlaps with the product area.

Note that existing object detection algorithms are object detection algorithms that use deep learning, such as Faster R-CNN (Convolutional Neural Network). Furthermore, an object detection algorithm such as YOLO (You Only Look One) or SSD (Single Shot Multibox Detector) may be used. Additionally, existing skeletal estimation algorithms are skeletal estimation algorithms using deep learning, such as Human Pose Estimation such as DeepPose and OpenPose.

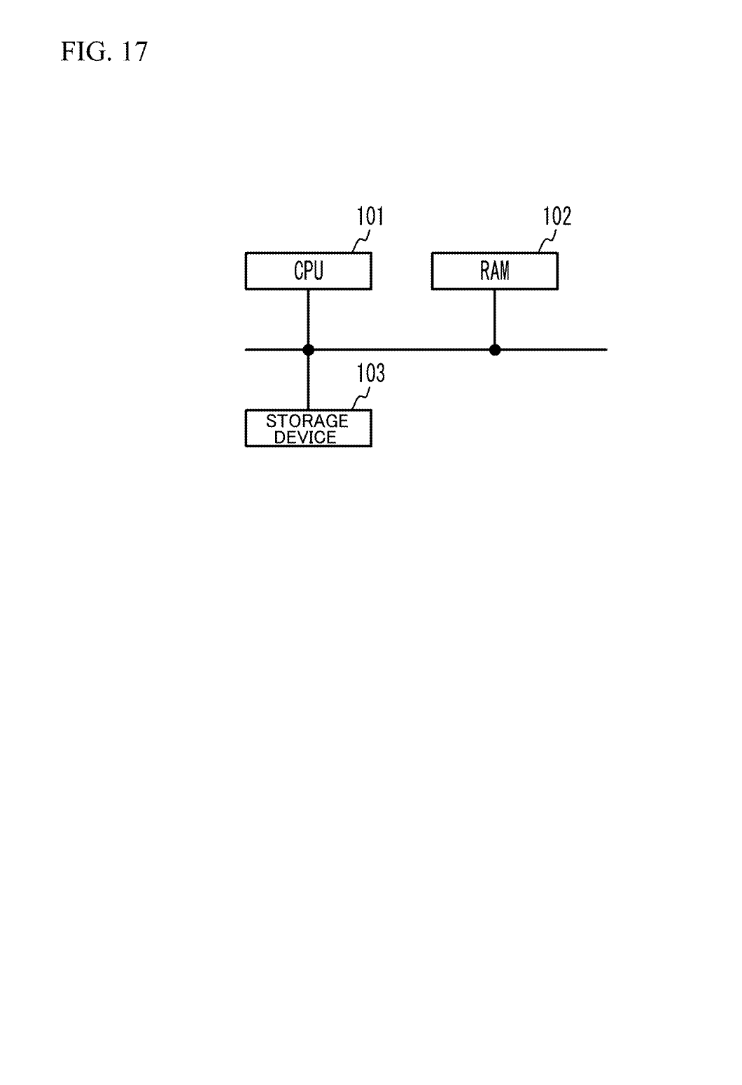

FIG. 17 is a block diagram illustrating the hardware configuration of the information processing device 100. As illustrated in FIG. 17, the information processing device 100 includes a CPU 101, a RAM 102, a storage device 103, and the like. The CPU (Central Processing Unit) 101 is a central processing unit. The RAM (Random Access Memory) 102 is a volatile memory that temporarily stores programs executed by the CPU 101 and data processed by the CPU 101. The storage device 103 is a nonvolatile storage device. The storage device 103 can be, for example, a ROM (Read Only Memory), a solid state drive (SSD), such as a flash memory, or a hard disk driven by a hard disk drive. The CPU 101 executes the determination program stored in the storage device 103, and functions of each part of the information processing device 100 are realized. The functions of each part of the information processing device 100 may be made up of a dedicated circuit or the like.

In the above embodiment, the point determiner 18 is an example of a determiner which determines the location where the service providing device will start providing the service in accordance with the detected movement of the target, when a target indicating a person approaching the service providing device is detected based on the result of analyzing an image taken by the camera. The instructor 20 is an example of an instructor which instructs the service providing device to start providing the service, when the target enters the location determined by the determiner. The location information storage 13 is an example of a storage which stores the identification information of the target and the location information of the target in association with each other. The speed measurer 14 is an example of a measurer which measures the movement of the target from an image acquired from a camera. Alternatively, the speed measurer 14 is an example of a measurer which measures the movement of the target by referring to a storage that stores the identification information of the target with the location information of the target. Alternatively, the speed measurer 14 is an example of a measurer which measures the movement of the target by using statistical processing. Alternatively, the speed measurer 14 is an example of a measurer which measures an average movement of the target for a given time. The content adjuster 19 is an example of an adjuster which adjusts a content of the service provided by the service providing device, in accordance with the number of people approaching the service provided device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. For example, the above-described coolant may be cold water or an antifreeze solution.

What is claimed is:

1. A determination method comprising:
when an object indicating a person approaching a service providing device is detected based on a result of analyzing an image taken by a camera, determining a location where the service providing device will start providing a service, in accordance with a movement of the target.

2. The determination method as claimed in claim 1,
wherein, when the target enters the location determined in the determining, the service providing device is instructed to start providing the service.

3. The determination method as claimed in claim 1,
wherein, the faster the movement of the target, the farther the location where the service providing device starts providing the service is moved from the service providing device, and the slower the movement of the target, the closer the location where the service providing device starts providing the service is moved to the service providing device.

4. The determination method as claimed in claim 1,
wherein a range of the location where the service providing device starts providing the service is adjusted according to the movement of the target.

5. The determination method as claimed in claim 1,
wherein the movement of the target is measured from an image acquired from a camera.

6. The determination method as claimed in claim 1,
wherein the movement of the target is measured by referring to a storage that stores identification information of the target and location information of the target in association with each other.

7. The determination method as claimed in claim 1,
wherein the movement of the target is measured using statistical processing

8. The determination method as claimed in claim 1,
wherein an average movement of the target is measured over a given time period.

9. The determination method as claimed in claim 1,
wherein a content of the service provided by the service providing device is adjusted according to a number of people approaching the service providing device.

10. The determination method as claimed in claim 1,
wherein movements of a plurality of objects within a specific range is detected, and a location where the service providing device starts providing the service is determined according to the movement of the plurality of objects.

11. The determination method as claimed in claim 1,
wherein a movement of a specific object among a plurality of objects within a specific range is detected, and the location where the service providing device starts providing the service is determined according to the movement of the specific object.

12. The determination method as claimed in claim 1,
wherein the service providing device for providing the service is determined among a plurality of service providing devices, in accordance with the movement of the target.

13. A control method comprising:
acquiring biometric information of a person passing through a gate located at a specific location in a facility, based on biometric information detection of the person by a sensor or camera mounted on the gate;
when authentication using the biometric information of the person is successful, analyzing an image including the person passing through the gate and identifying the person included in the image as a person who checked in to the facility; and
tracking the person identified, while identifying identification information of the person identified based on the biometric information.

14. The control method as claimed in claim 13,
wherein the service providing device starts a service application related to the identification information of the person identified based on the biometric information.

15. The control method as claimed in claim 13,
wherein the facility is a store,
wherein the gate is disposed at an entrance of the store,
wherein, if the biometric information acquired from the person is registered as a member of the store, it is determined that authentication using the biometric information of the person has been successful, and
wherein, by tracking a person moving in the store, a purchasing behavior of the person from a time the person enters the store until the person leaves the store is identified.

16. The control method as claimed in claim 15,
wherein by analyzing an image including the person who is tracked, skeletal information of the person is generated, and
wherein by using the skeletal information, it is determined whether or not the person who is tracked has performed an action of acquiring a product placed in the store, as the purchasing behavior.

17. The control method as claimed in claim 13,
wherein the facility is either a railway facility or an airport,
wherein the gate is located at a ticket gate of the railway facility, a counter of the airport, or an inspection area of the airport, and
wherein, if the biometric information of the person is pre-registered as a train or airplane passenger, it is determined that authentication using the biometric information of the person has been successful.

18. A non-transitory computer-readable recording medium that stores a program causing a computer to execute a process, the process including:
when an object indicating a person approaching a service providing device is detected based on a result of analyzing an image taken by a camera, determining a location wherein the service providing device will start providing a service in accordance with a movement of the target detected.

19. An information processing device comprising:
a memory; and
a processor coupled to the memory and configured to:
when an object indicating a person approaching a service providing device is detected based on a result of analyzing an image taken by a camera, determine a location wherein the service providing device will start providing a service in accordance with a movement of the target detected.
